(19) United States
(12) Patent Application Publication
(10) Pub. No.: US 2026/0162287 A1
(43) Pub. Date: Jun. 11, 2026

(54) METHOD AND APPARATUS FOR GENERATING DEPTH IMAGE, ELECTRONIC DEVICE, AND COMPUTER-READABLE STORAGE MEDIUM

(71) Applicant: Tencent Technology (Shenzhen) Company Limited, Shenzhen (CN)

(72) Inventor: Keyang Luo, Shenzhen (CN)

(21) Appl. No.: 19/181,767

(22) Filed: Apr. 17, 2025

Related U.S. Application Data
(63) Continuation of application No. PCT/CN2024/079637, filed on Mar. 1, 2024.

(30) Foreign Application Priority Data
Apr. 27, 2023 (CN) 202310477567.7

(51) Int. Cl. G06T 7/55; G06T 7/11; G06T 7/73; G06T 7/90

(52) U.S. Cl. CPC G06T 7/55; G06T 7/11; G06T 7/74; G06T 7/90; G06T 2207/10024; G06T 2207/20081; G06T 2207/20221

(57) ABSTRACT

A method and an apparatus for generating a depth image, an electronic device, and a computer-readable storage medium are provided. The method includes: acquiring a first sub-depth image that has depth information and a second sub-depth image that does not have depth information; acquiring a depth prediction model, the depth prediction model being obtained through training by taking pixels in a first color area in a color image as samples and taking the corresponding depth information in the first sub-depth image as a label; predicting depth information of each pixel in a second color area in the color image through the depth prediction model to obtain a third sub-depth image corresponding to the second color area; and fusing the first sub-depth image and the third sub-depth image to obtain a complete depth image corresponding to the color image.

### CROSS REFERENCE TO RELATED APPLICATIONS

This application is a continuation application of PCT Patent Application No. PCT/CN2024/079637, filed on Mar. 1, 2024, which claims priority to Chinese Patent Application No. 202310477567.7, filed on Apr. 27, 2023, each entitled “METHOD AND APPARATUS FOR GENERATING DEPTH IMAGE, ELECTRONIC DEVICE, COMPUTER-READABLE STORAGE MEDIUM, AND COMPUTER PROGRAM PRODUCT,” and each of which is incorporated herein by reference in its entirety.

### FIELD

The present disclosure relates to the field of computer technologies, and in particular, to a method and an apparatus for generating a depth image, an electronic device, a computer-readable storage medium, and a computer program product.

### BACKGROUND

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

In related technologies, a large quantity of samples usually need to be labeled in advance to train a machine learning model, and the trained machine learning model is configured for generating a depth image. In this case, the machine learning model configured for generating a depth image is only applicable to an application scenario related to samples. In another application scenario lacking samples, because the machine learning model is not effectively trained (samples in the another application scenario are missing), the performance of the trained machine learning model is poor in the another application scenario, resulting in poor scenario universality of generating a depth image.

### SUMMARY

Embodiments of the present disclosure provide a method and an apparatus for generating a depth image, an electronic device, a computer-readable storage medium, and a computer program product, which can effectively improve the scenario universality of generating a depth image.

Solutions in the embodiments of the present disclosure are implemented as follows:

Embodiments of the present disclosure provide a method for generating a depth image, including:
acquiring a first sub-depth image that has depth information and a second sub-depth image that does not have depth information,
the first sub-depth image and the second sub-depth image being obtained by dividing a depth image corresponding to a color image, the first sub-depth image corresponding to a first color area in the color image, and the second sub-depth image corresponding to a second color area in the color image;
acquiring a depth prediction model, the depth prediction model being obtained through training by taking pixels in the first color area in the color image as samples and taking corresponding depth information in the first sub-depth image as a label;
predicting depth information of each pixel in the second color area in the color image through the depth prediction model to obtain a third sub-depth image corresponding to the second color area; and
fusing the first sub-depth image and the third sub-depth image to obtain a complete depth image corresponding to the color image.

Embodiments of the present disclosure provide an apparatus for generating a depth image, including:
an image acquisition module, configured to acquire a first sub-depth image that has depth information and a second sub-depth image that does not have depth information, the first sub-depth image and the second sub-depth image being obtained by dividing a depth image corresponding to a color image, the first sub-depth image corresponding to a first color area in the color image, and the second sub-depth image corresponding to a second color area in the color image;
a model acquisition module, configured to acquire a depth prediction model, the depth prediction model being obtained through training by taking pixels in the first color area in the color image as samples and taking corresponding depth information in the first sub-depth image as a label;
a prediction module, configured to predict depth information of each pixel in the second color area in the color image through the depth prediction model to obtain a third sub-depth image corresponding to the second color area; and
a fusion module, configured to fuse the first sub-depth image and the third sub-depth image to obtain a complete depth image corresponding to the color image.

Embodiments of the present disclosure provide an electronic device, including:
a memory, configured to store computer-executable instructions or a computer program; and
a processor, configured to implement, when executing the computer-executable instructions or computer program stored in the memory, the method for generating a depth image provided in the embodiments of the present disclosure.

Embodiments of the present disclosure provide a non-transitory computer-readable storage medium, having computer-executable instructions stored therein, and configured to implement, when being executed by a processor, the method for generating a depth image provided in embodiments of the present disclosure.

Embodiments of the present disclosure provide a computer program product, the computer program product including a computer program or computer-executable instructions, the computer program or the computer-executable instructions being stored in a computer-readable storage medium. A processor of an electronic device reads the computer-executable instructions from the computer-readable storage medium, and the processor executes the computer-executable instructions, to cause the electronic device to perform the foregoing method for generating a depth image provided in the embodiments of the present disclosure.

Embodiments of the present disclosure have the following beneficial effects.

A first sub-depth image that has depth information, a second sub-depth image that does not have depth information, a first color area that is in a color image and corresponds to the first sub-depth image, and a second color area that is in the color image and corresponds to the second sub-depth image are acquired, depth information of each pixel in the second color area in the color image is predicted through a depth prediction model to obtain a third sub-depth image, and the first sub-depth image and the third sub-depth image are fused to obtain a complete depth image corresponding to the color image. In this case, in a training process of the depth prediction model, training is performed by using the pixels in the first color area in the color image as samples, and in a prediction process of the depth prediction model, the depth information of each pixel in the second color area in the color image is predicted. The first color area and the second color area are both from the same color image. Therefore, regardless of an application scenario in which the color image is a color image with depth information missing in some areas (i.e., the first color area in the color image has depth information and the second color area in the color image does not have depth information), through the first sub-depth image that corresponds to the color image and has depth information, the depth information of the second sub-depth image that does not have depth information can be predicted, so that in a process of generating a depth image, dependency on an application scenario is significantly reduced, thereby effectively decoupling a strong scenario coupling relationship between training samples and a generated depth image in a training process and an application process, and effectively improving scenario universality of generating a depth image.

### BRIEF DESCRIPTION OF THE DRAWINGS

FIG. 1 is a schematic diagram of an architecture of a system for generating a depth image according to an embodiment of the present disclosure.

FIG. 2 is a schematic structural diagram of an electronic device for generating a depth image according to an embodiment of the present disclosure.

FIG. 3 is a schematic flowchart 1 of a method for generating a depth image according to an embodiment of the present disclosure.

FIG. 4 is a schematic flowchart 2 of a method for generating a depth image according to an embodiment of the present disclosure.

FIG. 5 is a schematic flowchart 3 of a method for generating a depth image according to an embodiment of the present disclosure.

FIG. 6 is a schematic flowchart 4 of a method for generating a depth image according to an embodiment of the present disclosure.

FIG. 7 is a schematic structural diagram of a depth prediction model according to an embodiment of the present disclosure.

FIG. 8 is a schematic flowchart 5 of a method for generating a depth image according to an embodiment of the present disclosure.

### DETAILED DESCRIPTION

The following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, the “some embodiments” may be the same subset or different subsets of all the possible embodiments, and may be combined with each other without conflict.

The terms, involved in the following description, “first/second/third” is merely intended to distinguish similar objects rather than describing specific orders. “First/second/third” is interchangeable in proper circumstances to enable the embodiments of the present disclosure to be implemented in other orders than those illustrated or described herein.

Unless otherwise defined, meanings of all technical and scientific terms used in this specification are the same as those usually understood by a person skilled in the art to which the present disclosure belongs. Terms used herein are merely intended to describe the embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

(1) AI: AI involves a theory, a method, a technology, and an application system that use a digital computer or a machine controlled by the digital computer to simulate, extend, and expand human intelligence, perceive an environment, obtain knowledge, and use knowledge to obtain an optimal result. AI technology is a comprehensive discipline and covers a wide range of fields, and includes both technologies at the hardware level and technologies at the software level. Fundamental AI technologies generally include sensors, dedicated AI chips, cloud computing, distributed storage, a big data processing technology, operating/interaction systems, mechatronics, and other technologies.

(2) A convolutional neural network (CNN) is a type of feedforward neural network (FNN) including convolutional computation and having a deep structure, and is one of the representative algorithms of deep learning. The CNN has a representation learning capability, and can perform shift-invariant classification on an input image according to a hierarchical structure thereof.

(3) Convolutional layer: Each Convolutional layer in the CNN is formed by a plurality of convolutional units, and a parameter of each convolutional unit is obtained through optimization by using a back propagation algorithm. An objective of the convolution operation is to extract different features of an input. The first convolutional layer may be only capable of extracting some low-level features such as edges, lines, and corners. More layers of networks can iteratively extract more complex features from the low-level features.

(4) Pooling layer: After the convolutional layer performs feature extraction, an outputted feature map is transferred to the pooling layer for feature selection and information filtering. The pooling layer includes a preset pooling function, the function of which is to replace a result of a single point in the feature map with a feature map statistic of an adjacent area thereof. The operation of selecting a pooling area by the pooling layer is the same as that of scanning the feature map by a convolutional kernel, and is controlled by a pooling size, a step size, and filling.

(5) Fully-Connected Layer: The fully-connected layer in the CNN is equivalent to a hidden layer in a conventional FNN. The fully-connected layer is located at the last part of a hidden layer of the CNN, and transfers a signal only to another fully-connected layer. The feature map loses a spatial topology structure in the fully-connected layer, is flattened into a vector, and passes through an excitation function.

(6) Game program: The game program may be any one of a massively multiplayer online role-playing game (MMORPG), a first-person shooting (FPS) game, a third-person shooting game, a multiplayer online battle arena (MOBA) game, a virtual reality application, a three-dimensional map program, a simulation program, or a multiplayer shooter survival game.

(7) Depth image: The depth image is also referred to as a depth map. A pixel value of each pixel in the depth image is configured for indicating a pixel depth of the pixel, or configured for indicating a distance between a physical point corresponding to the pixel in a physical scene and a camera. The pixel depth is a quantity of bits configured for storing each pixel, and is also configured for measuring a resolution of an image. The pixel depth determines a quantity of colors that each pixel of a color image may have, or determines a quantity of grayscale levels that each pixel of a grayscale image may have. For example, each pixel of one color image is represented by using three components: R, G, and B. If each component is represented by using 8 bits, one pixel is represented by using a total of 24 bits. That is, a depth of the pixel is 24, and each pixel may be one of 16777216 (2 to the power of 24) colors. In this sense, a pixel depth is usually referred to as an image depth. When one pixel is represented by using a larger quantity of bits, a quantity of colors that can be represented by the pixel is larger, and a depth of the pixel is larger.

(8) The color image may be an image in an RGB color mode. The RGB color mode is a color standard in the industry, and obtains various colors by changing channels of three color channels red (R), green (G), and blue (B) and through superimposition of the channels. RGB represents colors of the channels R, G, and B. The standard almost includes all colors perceptible to human eyesight, and is one of the most widely used color systems.

In an implementation process of embodiments of the present disclosure, the applicant finds that the related technology has the following problems:

In related technologies, a large quantity of samples usually need to be labeled in advance to train a machine learning model, and the trained machine learning model is configured for generating a depth image. In this case, the machine learning model configured for generating a depth image is only applicable to an application scenario related to samples. In another application scenario lacking samples, because the machine learning model is not effectively trained (samples in the another application scenario are missing), the performance of the trained machine learning model is poor in the another application scenario, resulting in poor scenario universality of generating a depth image.

In the related technology, conventional depth map completion greatly depends on a priori knowledge of a person skilled in the art, scenario features, and characteristics of a data collection device. When the foregoing characteristics change, an appropriate and ideal depth completion result usually cannot be obtained, and the method has weak universality. Supervised learning-based depth map completion method: This type of method requires a large amount of labeled data with a depth for training, and data collection and labeling costs are very high. In addition, this type of method can only be applied to a scenario similar to training data. When a scenario change is large, depth completion performance usually significantly decreases, and the method also has poor universality performance. Unsupervised learning-based depth map completion has a high requirement on camera parameter accuracy of an incomplete depth map on which the depth map completion depends, and it is very difficult to acquire camera parameter information. In addition, this type of method also depends on training data to a great extent, and cannot be directly applied to a scenario greatly different from training data, and the method also has poor universality performance. In view of the foregoing disadvantages of the related technology, in embodiments of the present disclosure, scenario universality of generating a depth image is improved by using a self-supervised learning strategy. The embodiments of the present disclosure provide training of a depth prediction model by relying on only one incomplete depth map and depth completion of the incomplete depth map by using a trained depth prediction model. In the embodiments of the present disclosure, large-scale labeled data is not required for training, and depth information of an unknown depth area can be deduced only through understanding and encoding a known scene area in the incomplete depth map, thereby greatly reducing dependency on data and scenarios, and greatly improving scenario universality of generating a depth image.

Embodiments of the present disclosure provide a method and an apparatus for generating a depth image, an electronic device, a computer-readable storage medium, and a computer program product, which can effectively improve the scenario universality of generating a depth image. The following describes an exemplary application of a system for generating a depth image provided in embodiments of the present disclosure.

FIG. 1 is a schematic diagram of an architecture of a system 100 for generating a depth image according to an embodiment of the present disclosure. A terminal (a terminal 400 is shown exemplarily) is connected to a server 200 by a network 300. The network 300 may be a wide area network, a local area network, or a combination of the two.

A terminal 400 is configured to display a complete depth image on a graphical interface 410-1 (the graphical interface 410-1 is exemplarily shown) for use of a client 410 by a user. The terminal 400 and the server 200 are connected to each other by a wired or wireless network.

In some embodiments, the server 200 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 400 may be a smartphone, a tablet computer, a laptop computer, a desktop computer, a smart speaker, a smart television, a smartwatch, an in-vehicle terminal, an augmented reality device, a game device, or the like, but is not limited thereto. The electronic device provided in the embodiments of the present disclosure may be implemented as a terminal, or may be implemented as a server. The terminal and the server may be connected directly or indirectly in a wired or wireless communication manner, which is not limited in the embodiments of the present disclosure.

In some embodiments, the terminal 400 acquires a first sub-depth image and a second sub-depth image, acquires a depth prediction model, predicts depth information of each pixel in a second color area in a color image through the depth prediction model to obtain a third sub-depth image, fuses the third sub-depth image and the first sub-depth image to obtain a complete depth image, and sends the complete depth image to the server 200.

In some other embodiments, the server 200 acquires a first sub-depth image and a second sub-depth image, acquires a depth prediction model, predicts depth information of each pixel in a second color area in a color image through the depth prediction model to obtain a third sub-depth image, fuses the third sub-depth image and the first sub-depth image to obtain a complete depth image, and sends the complete depth image to the terminal 400.

In some other embodiments, the embodiments of the present disclosure may alternatively be implemented by using a cloud technology. The cloud technology is a hosting technology that unifies a series of resources such as hardware, software, and networks within a wide area network or a local area network to implement calculation, storage, processing, and sharing of data.

The cloud technology is a generic term of a network technology, an information technology, an integration technology, a management platform technology, and an application technology based on application of a cloud computing business model. The resources may form a resource pool and are used on demand, which is flexible and convenient. A cloud computing technology becomes an important support. Backend services of a technical network system require a lot of computing and storage resources.

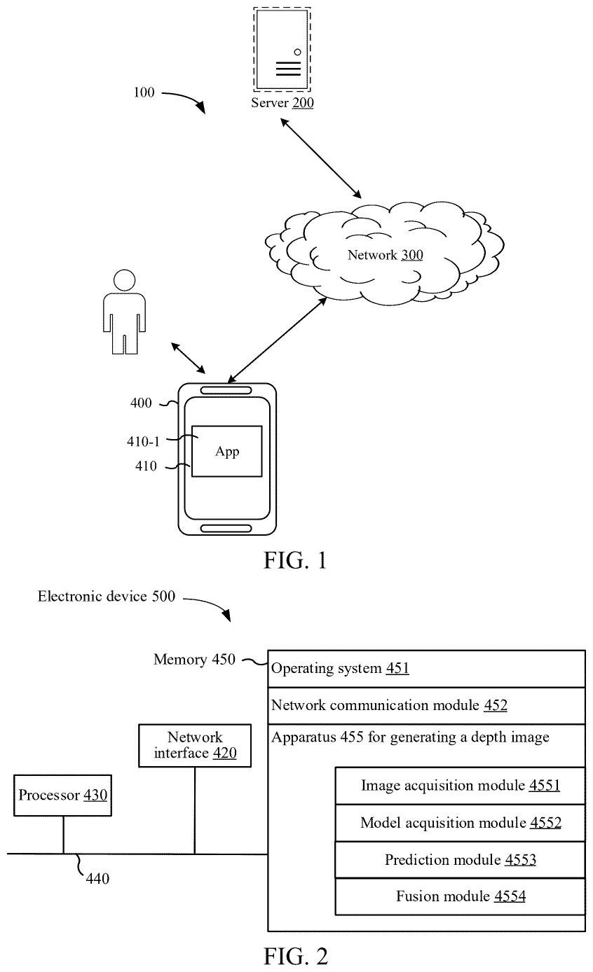

FIG. 2 is a schematic structural diagram of an electronic device 500 for generating a depth image according to an embodiment of the present disclosure. The electronic device 500 shown in FIG. 2 may be the server 200 or the terminal 400 shown in FIG. 1. The electronic device 500 shown in FIG. 2 includes at least one processor 430, a memory 450, and at least one network interface 420. Components in the electronic device 500 are coupled together by a bus system 440. The bus system 440 is configured to implement connection and communication between the components. In addition to a data bus, the bus system 440 further includes a power bus, a control bus, and a status signal bus. However, for ease of description, all types of buses in FIG. 2 are marked as the bus system 440.

The processor 430 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The memory 450 may be a removable memory, a non-removable memory, or a combination thereof. An exemplary hardware device includes a solid-state memory, a hard disk drive, an optical disk drive, and the like. In some embodiments, the memory 450 includes one or more storage devices having physical locations far away from the processor 430.

The memory 450 includes a volatile memory or a non-volatile memory, or may include a volatile memory and a non-volatile memory. The non-volatile memory may be a read-only memory (ROM), and the volatile memory may be a random access memory (RAM). The memory 450 described in the embodiments of the present disclosure aims to include any suitable type of memories.

In some embodiments, the memory 450 can store data to support various operations. Examples of the data include a program, a module, a data structure, or a subset or superset thereof, and are exemplarily described below.

An operating system 451 includes system programs configured for processing various basic system services and performing hardware-related tasks, for example, a framework layer, a kernel library layer, and a driver layer, and is configured to implement various basic services and process hardware-based tasks.

A network communication module 452 is configured to reach another electronic device through one or more (wired or wireless) network interfaces 420. An exemplary network interface 420 includes Bluetooth, wireless fidelity (Wi-Fi), a universal serial bus (USB), and the like.

In some embodiments, an apparatus for generating a depth image provided in the embodiments of the present disclosure may be implemented in a software manner. FIG. 2 shows an apparatus 455 for generating a depth image stored in the memory 450. The apparatus may be software in a form of a program, a plug-in, or the like, and includes the following software modules: an image acquisition module 4551, a model acquisition module 4552, a prediction module 4553, and a fusion module 4554. These modules are logical modules, and therefore may be combined or split in any manner according to functions to be further implemented. The functions of the modules are described below.

In some other embodiments, the apparatus for generating a depth image provided in the embodiments of the present disclosure may be implemented in a hardware manner. In an example, the apparatus for generating a depth image provided in the embodiments of the present disclosure may be a processor in the form of a hardware decoding processor, and is programmed to perform a method for generating a depth image provided in the embodiments of the present disclosure. For example, the processor in the form of a hardware decoding processor may use one or more application-specific integrated circuits (ASICs), a DSP, a PLD, a complex PLD (CPLD), a field programmable gate array (FPGA), or another electronic element.

In some embodiments, the terminal or the server may implement the method for generating a depth image provided in embodiments of the present disclosure by running a computer program or computer-executable instructions. For example, the computer program may be a native program (for example, a dedicated program for generating a depth image) or a software module in an operating system, for example, a module for generating a depth image that may be embedded in any program (for example, an instant messaging client, an album program, an electronic map client, or a navigation client), or may be a native application (APP), i.e., a program that needs to be installed in the operating system for running. In summary, the foregoing computer program may be an application, a module, or a plug-in in any form.

A method for generating a depth image provided in embodiments of the present disclosure is described with reference to exemplary applications and implementations of the server or terminal provided in the embodiments of the present disclosure.

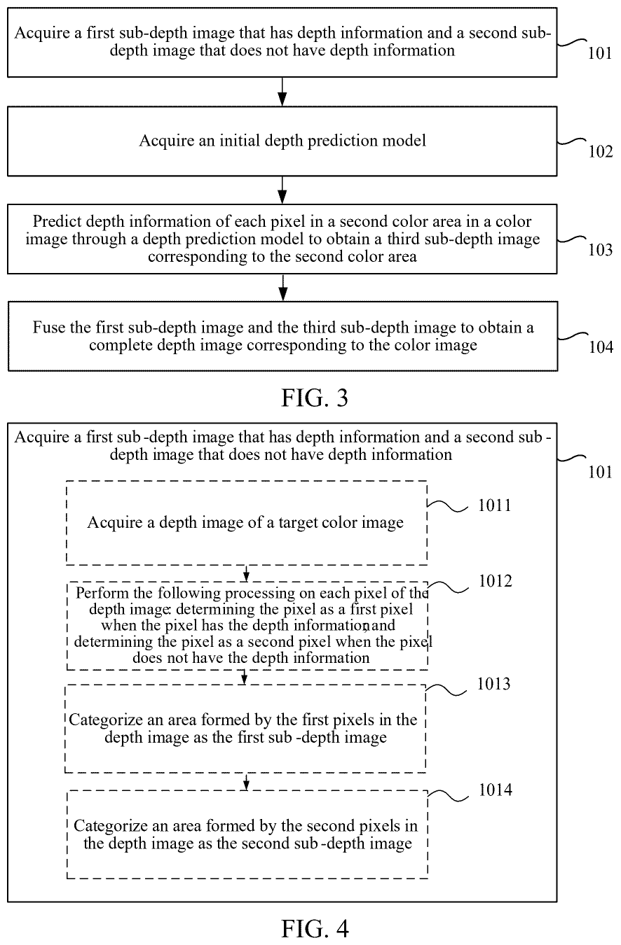

FIG. 3 is a schematic flowchart 1 of a method for generating a depth image according to an embodiment of the present disclosure. Descriptions are provided with reference to operation 101 to operation 104 shown in FIG. 3. The method for generating a depth image provided in the embodiments of the present disclosure may be independently implemented by a server or a terminal, or may be cooperatively implemented by a server and a terminal. The following describes an example in which the method is independently implemented by a server.

Operation 101: Acquire a first sub-depth image that has depth information and a second sub-depth image that does not have depth information.

In some embodiments, the first sub-depth image and the second sub-depth image are obtained by dividing a depth image corresponding to a color image, the first sub-depth image corresponds to a first color area in the color image, and the second sub-depth image corresponds to a second color area in the color image.

As an example, for a color image A, the color image A includes a first color area A1 and a second color area A2. An image corresponding to the first color area A1 in a depth image corresponding to the color image A is the first sub-depth image, and an image corresponding to the second color area A2 in the depth image corresponding to the color image A is the second sub-depth image.

In some embodiments, the color image may be an image in an RGB color mode. The RGB color mode is a color standard in the industry, and obtains various colors by changing channels of three color channels R, G, and B and through superimposition of the channels. RGB represents colors of the channels R, G, and B. The standard almost includes all colors perceptible to human eyesight, and is one of the most widely used color systems.

In some embodiments, pixels in the first sub-depth image are in a one-to-one correspondence with pixels in the first color area in the color image, pixels in the second sub-depth image are in a one-to-one correspondence with pixels in the second color area in the color image, a pixel in the first sub-depth image is configured for indicating depth information of the pixel, a pixel in the first color area is configured for indicating color information of the pixel, and image content indicated by the pixels in the first sub-depth image is the same as that indicated by the pixels in the first color area.

In some embodiments, FIG. 4 is a schematic flowchart 2 of a method for generating a depth image according to an embodiment of the present disclosure. Operation 101 shown in FIG. 3 is implemented through operation 1011 to operation 1014 shown in FIG. 4.

Operation 1011: Acquire the depth image corresponding to the color image.

As an example, an expression of image information of each pixel in the color image may be:

$${V}_{p} = [ {u}_{p} , {v}_{p} , {r}_{p} , {g}_{p} , {b}_{p} ] . \qquad ( 1 )$$

Vₚ is configured for indicating image information of a pixel p, uₚ is configured for indicating a horizontal coordinate of the pixel p in the color image, vₚ is configured for indicating a vertical coordinate of the pixel p in the color image, and rₚ, gₚ, and bₚ respectively indicate color values of three color channels of the pixel p.

As an example, an expression of image information of a corresponding pixel in the depth image corresponding to the color image may be:

$${U}_{p} = [ {u}_{p} , {v}_{p} , {D}_{0}^{p} ] . \qquad ( 2 )$$

Uₚ is configured for indicating the image information of the pixel p, uₚ is configured for indicating a horizontal coordinate of the pixel p in the depth image, vₚ is configured for indicating a vertical coordinate of the pixel p in the depth image, and

$${D}_{0}^{p}$$

depth information of the pixel p. When the pixel p is in the first sub-depth image,

$${D}_{0}^{p} > 0.$$

When the pixel p is in the second sub-depth image,

$${D}_{0}^{p} = 0.$$

In some embodiments, because the depth image corresponding to the color image and the color image have the same image size and pixels that are in a one-to-one correspondence, a reference coordinate system of the color image is a coordinate system using an origin pixel of the color image as an origin, and the depth image corresponding to the color image is a coordinate system using an origin pixel of the depth image corresponding to the color image as an origin. The reference coordinate system of the color image completely overlaps a reference coordinate system of the depth image corresponding to the color image. Therefore, coordinates of a pixel in the depth image corresponding to the color image are the same as those of a corresponding pixel in the color image.

Operation 1012: Perform the following processing on each pixel of the depth image: determining the pixel as a first pixel when the pixel has the depth information; and determining the pixel as a second pixel when the pixel does not have the depth information.

In some embodiments, before the foregoing operation 1012 is performed, it may be determined, in the following manner, whether a pixel has depth information; and the following processing is performed on each pixel of the depth image: comparing a value of depth information of the pixel with zero, and determining, when a comparison result indicates that the value of the depth information of the pixel is greater than zero, that the pixel has depth information; and determining, when the value of the depth information of the pixel is equal to zero, that the pixel does not have depth information.

As an example, a pixel A in the depth image has depth information, and the pixel A is determined as the first pixel; and a pixel B in the depth image does not have depth information, and the pixel B is determined as the second pixel.

Operation 1013: Categorize an area formed by the first pixels in the depth image as the first sub-depth image.

As an example, the first pixel in the depth image includes a pixel A, a pixel C, and a pixel D, and an area formed by the pixel A, the pixel C, and the pixel D is categorized as the first sub-depth image.

Operation 1014: Categorize an area formed by the second pixels in the depth image as the second sub-depth image.

As an example, the first pixel in the depth image includes a pixel B, a pixel E, and a pixel F, and an area formed by the pixel B, the pixel E, and the pixel F is categorized as the second sub-depth image.

In this way, the depth image (the depth image corresponding to the color image) lacking depth information is divided into the first sub-depth image and the second sub-depth image according to whether depth information exists, to subsequently train an initial depth prediction model based on the first color area in the color image corresponding to the first sub-depth image that has depth information. The depth information of the second sub-depth image is predicted by using a trained depth prediction model. Because a training sample (the first sub-depth image) and a to-be-predicted image (the second sub-depth image) both come from the depth image corresponding to the color image, the trained depth prediction model is more sensitive to the second sub-depth image. The depth prediction model is trained in real time in a prediction process, thereby effectively improving the universality of the trained depth prediction model.

Operation 102: Acquire a depth prediction model.

In some embodiments, the depth prediction model is obtained through training by taking pixels in the first color area in the color image as samples and taking corresponding depth information in the first sub-depth image as a label.

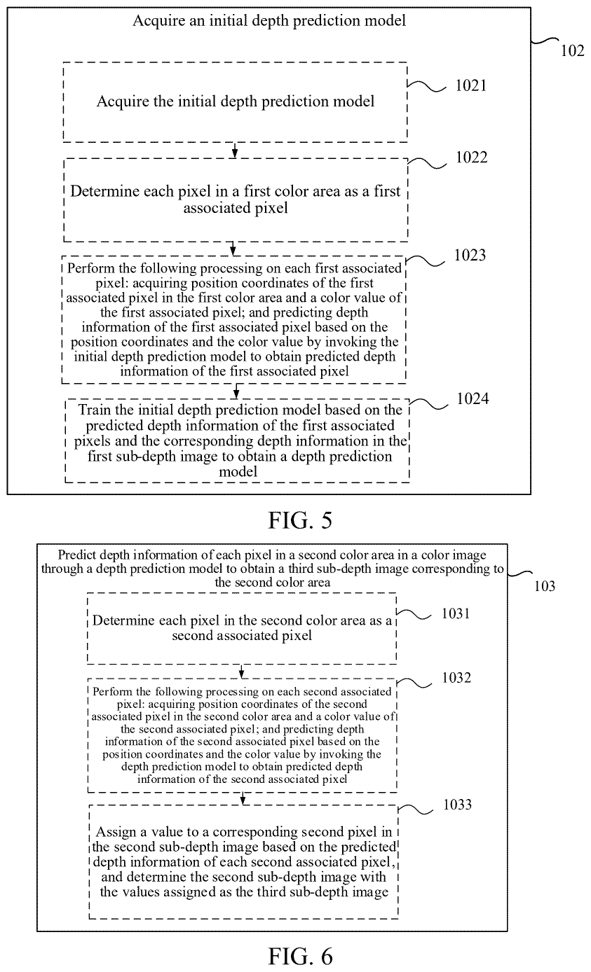

In some embodiments, FIG. 5 is a schematic flowchart 3 of a method for generating a depth image according to an embodiment of the present disclosure. Operation 102 shown in FIG. 3 is implemented through operation 1021 to operation 1024 shown in FIG. 5.

Operation 1021: Acquire the initial depth prediction model.

In some embodiments, the initial depth prediction model may be any type of AI prediction model, and a model structure of the initial depth prediction model does not constitute a limitation on the embodiments of the present disclosure. For example, the initial depth prediction model includes an encoding layer and a decoding layer. Feature extraction is performed on an image through the encoding layer to obtain an image feature, and prediction is performed based on the image feature through the decoding layer to obtain a predicted depth of the image.

Operation 1022: Determine each pixel in the first color area as a first associated pixel.

As an example, the first color area includes a pixel A, a pixel B, and a pixel C. The pixel A, the pixel B, and the pixel C are all determined as first associated pixels.

Operation 1023: Perform the following processing on each first associated pixel: acquiring position coordinates of the first associated pixel in the first color area and a color value of the first associated pixel; and predicting depth information of the first associated pixel based on the position coordinates and the color value by invoking the initial depth prediction model to obtain predicted depth information of the first associated pixel.

As an example, an expression of position coordinates of a first associated pixel m in the first color area may be:

$${W}_{m} = ( {u}_{m} , {v}_{m} ) . \qquad ( 3 )$$

Wₘ is configured for indicating position coordinates of a first associated pixel p within the first color area, uₘ is configured for indicating a horizontal coordinate of the first associated pixel m in the first color area, and vₘ is configured for indicating a vertical coordinate of the first associated pixel m in the first color area.

As an example, an expression of a color value of the first associated pixel p may be:

$${Y}_{m} = ( {r}_{m} , {g}_{m} , {b}_{m} ) . \qquad ( 4 )$$

Yₘ is configured for indicating a color value of the first associated pixel m, and rₘ, gₘ, and bₘ respectively indicate color values of three color channels of the pixel m.

In some embodiments, the predicting depth information of the first associated pixel based on the position coordinates and the color value by invoking the initial depth prediction model to obtain predicted depth information of the first associated pixel may be implemented in the following manner: standardizing the position coordinates to obtain standard position coordinates; standardizing the color value to obtain a standard color value; and predicting the depth information of the first associated pixel based on the standard position coordinates and the standard color value by invoking the initial depth prediction model to obtain the predicted depth information of the first associated pixel.

In some embodiments, the position coordinates and the color value are respectively standardized to obtain the standard position coordinates and the standard color value. The initial depth prediction model is trained based on the standard position coordinates and the standard color value, so that the initial depth prediction model can be more sensitive to standard data, thereby effectively improving the training efficiency of the initial depth prediction model.

In some embodiments, the foregoing standardization is a processing process of converting data (position coordinates, color values, and the like) into corresponding standard data according to a unified standard.

In some embodiments, the position coordinates include a horizontal coordinate and a vertical coordinate; and the standardizing the position coordinates to obtain standard position coordinates may be implemented in the following manner: acquiring a first pixel quantity in a horizontal axis direction and a second pixel quantity in a vertical axis direction of the color image; subtracting 1 from the first pixel quantity to obtain a first reference quantity, and subtracting 1 from the second pixel quantity to obtain a second reference quantity; determining a ratio of the horizontal coordinate to the first reference quantity as a standard horizontal coordinate; determining a ratio of the vertical coordinate to the second reference quantity as a standard vertical coordinate; and combining the standard horizontal coordinate and the standard vertical coordinate into the standard position coordinates.

In some embodiments, the color value includes a channel color value of each color channel, and the standardizing the color value to obtain a standard color value may be implemented in the following manner: performing the following processing on the channel color value of each color channel: acquiring a mean and a variance of the channel color value of the color channel; subtracting the mean from the channel color value to obtain a reference value; determining a ratio of the reference value to the variance as a standard channel color value corresponding to the channel color value; and combining the standard channel color values of the color channels into the standard color value.

In this way, the position coordinates and the color value are respectively standardized to obtain the standard position coordinates and the standard color value. The initial depth prediction model is trained based on the standard position coordinates and the standard color value, so that the initial depth prediction model can be more sensitive to standard data, thereby effectively improving the training efficiency of the initial depth prediction model.

Operation 1024: Train the initial depth prediction model based on the predicted depth information of the first associated pixels and the corresponding depth information in the first sub-depth image to obtain a depth prediction model.

In some embodiments, a quantity of training times of the initial depth prediction model is equal to a quantity of the first associated pixels. In other words, the initial depth prediction model is trained once through predicted depth information of one first associated pixel and corresponding depth information in the first sub-depth image. The initial depth prediction model is trained by using the predicted depth information of the first associated pixels to obtain the depth prediction model.

In some embodiments, operation 1024 may be implemented in the following manner: standardizing the depth information of each pixel in the first sub-depth image to obtain standard depth information; and training the initial depth prediction model based on the predicted depth information of the first associated pixels and the corresponding standard depth information in the first sub-depth image to obtain the depth prediction model.

As an example, an expression of the standard depth information may be:

$${D}_{0}^{p} = \frac{{d}_{0}^{p}}{{d}_{max}^{*} - {d}_{min}^{*}} . \qquad ( 5 )$$

$${D}_{0}^{p}$$

is configured for indicating the standard depth information,

$${d}_{0}^{p}$$

is configured for indicating the predicted depth information,

$${d}_{max}^{*}$$

is configured for indicating first reference depth information, and

$${d}_{min}^{*}$$

is configured for indicating second reference depth information.

As an example, an expression of the first reference depth information may be:

$${d}_{max}^{*} = ( 1 + {α}_{max} ) {d}_{max} . \qquad ( 6 )$$

$${d}_{max}^{*}$$

is configured for indicating the first reference depth information, αₘₐₓ is configured for indicating a first depth scaling factor, and dₘₐₓ is configured for indicating a maximum value in the predicted depth information of the first associated pixels.

As an example, an expression of the second reference depth information may be:

$${d}_{min}^{*} = ( 1 - {α}_{min} ) {d}_{min} . \qquad ( 7 )$$

$${d}_{min}^{*}$$

is configured for indicating the second reference depth information, αₘᵢₙ is configured for indicating a second depth scaling factor, and dₘᵢₙ is configured for indicating a minimum value in the predicted depth information of the first associated pixels.

In some embodiments, the predicted depth information of the first associated pixel is obtained by performing prediction based on the standard position coordinates and the standard color value. Therefore, the predicted depth information of the first associated pixel has a standardized format. Therefore, the depth information of each pixel in the first sub-depth image may be standardized to obtain the standard depth information, so that the standard depth information and the predicted depth information are in the same standardized format. Further, the initial depth prediction model is trained by using the predicted depth information of the first associated pixels in the standardized format and the corresponding standard depth information in the first sub-depth image to obtain the depth prediction model, so that the obtained depth prediction model can be more sensitive to standard data, thereby effectively improving the training efficiency of an initial depth prediction model.

In some embodiments, the training the initial depth prediction model based on the predicted depth information of the first associated pixels and the corresponding standard depth information in the first sub-depth image to obtain the depth prediction model may be implemented in the following manner: performing the following processing on each first associated pixel: determining, in the first sub-depth image, a first pixel corresponding to the first associated pixel, and acquiring standard depth information of the first pixel; determining a difference between the standard depth information of the first pixel and the predicted depth information of the first associated pixel as a first loss value of the first associated pixel; summing the first loss values of the first associated pixels to obtain a summed loss value; and training the initial depth prediction model based on the summed loss value to obtain the depth prediction model.

As an example, an expression of the summed loss value may be:

$$L = {\sum }_{i = 1}^{n} \vert {d}_{i} - {D}_{i} \vert . \qquad ( 8 )$$

L is configured for indicating the summed loss value, dᵢ is configured for indicating standard depth information of an i^{th} first pixel, Dᵢ is configured for indicating predicted depth information of an i^{th} first associated pixel, and dᵢ−Dᵢ is configured for indicating the first loss value.

In some embodiments, the training the initial depth prediction model based on the summed loss value to obtain the depth prediction model may be training parameters of the initial depth prediction model based on the summed loss value in a gradient update manner to obtain the depth prediction model.

Operation 103: Predict depth information of each pixel in the second color area in the color image through the depth prediction model to obtain a third sub-depth image corresponding to the second color area.

In some embodiments, the depth information of each pixel in the second color area in the color image is predicted by invoking the depth prediction model to obtain the depth information of each pixel in each second color area, and a value of the depth information of each pixel in the second color area is assigned to the corresponding pixel in the second sub-depth image to obtain the third sub-depth image.

In some embodiments, FIG. 6 is a schematic flowchart 4 of a method for generating a depth image according to an embodiment of the present disclosure. Operation 103 shown in FIG. 3 is implemented through operation 1031 to operation 1033 shown in FIG. 6.

Operation 1031: Determine each pixel in the second color area as a second associated pixel.

As an example, pixels in the second color area include a pixel A, a pixel B, and a pixel C. The pixel A, the pixel B, and the pixel C are respectively determined as second associated pixels.

Operation 1032, the following processing is performed on each second associated pixel: acquiring position coordinates of the second associated pixel in the second color area and a color value of the second associated pixel; and predicting depth information of the second associated pixel based on the position coordinates and the color value by invoking the depth prediction model to obtain predicted depth information of the second associated pixel.

Continuing with the foregoing example, for the pixel A, position coordinates (position coordinates of the pixel A in a coordinate system using an origin of the color image as a coordinate origin) of the pixel A in the second color area and a color value of the pixel A are acquired. The depth information of the second associated pixel is predicted based on the position coordinates and the color value of the pixel A by invoking the depth prediction model to obtain predicted depth information of the pixel A.

In some embodiments, the predicting depth information of the second associated pixel based on the position coordinates and the color value by invoking the depth prediction model to obtain predicted depth information of the second associated pixel may be implemented in the following manner: standardizing the position coordinates to obtain standard position coordinates; standardizing the color value to obtain a standard color value; and predicting the depth information of the second associated pixel based on the standard position coordinates and the standard color value by invoking the depth prediction model to obtain initial depth information of the second associated pixel; and destandardizing the initial depth information to obtain the predicted depth information of the second associated pixel.

In some embodiments, the position coordinates and the color value are respectively standardized to obtain the standard position coordinates and the standard color value. The initial depth prediction model is trained based on the standard position coordinates and the standard color value, so that the initial depth prediction model can be more sensitive to standard data, thereby effectively improving the training efficiency of the initial depth prediction model. When the depth information of the second associated pixel is predicted by invoking the trained depth prediction model, because training is performed based on standard data, during application, the position coordinates may be standardized to obtain the standard position coordinates. The color value is standardized to obtain the standard color value, and the depth information of the second associated pixel is predicted based on the standard position coordinates and the standard color value, so that the sensitivity of the depth prediction model to standard data can be efficiently used, thereby effectively improving the accuracy of predicting the depth information of the second associated pixel.

In some embodiments, the position coordinates include a horizontal coordinate and a vertical coordinate; and the standardizing the position coordinates to obtain standard position coordinates may be implemented in the following manner: acquiring a first pixel quantity in a horizontal axis direction and a second pixel quantity in a vertical axis direction of the color image; subtracting 1 from the first pixel quantity to obtain a first reference quantity, and subtracting 1 from the second pixel quantity to obtain a second reference quantity; determining a ratio of the horizontal coordinate to the first reference quantity as a standard horizontal coordinate; determining a ratio of the vertical coordinate to the second reference quantity as a standard vertical coordinate; and combining the standard horizontal coordinate and the standard vertical coordinate into the standard position coordinates.

As an example, an expression of the standard horizontal coordinate may be:

$${U}_{p} = \frac{{u}_{p}}{H - 1} . \qquad ( 9 )$$

Uₚ is configured for indicating the standard horizontal coordinate, uₚ is configured for indicating the horizontal coordinate, and H is configured for indicating the first pixel quantity.

As an example, an expression of the standard vertical coordinate may be:

$${V}_{p} = \frac{{v}_{p}}{W - 1} . \qquad ( 10 )$$

Vₚ is configured for indicating the standard vertical coordinate, vₚ is configured for indicating the vertical coordinate, and W is configured for indicating the second pixel quantity.

As an example, an expression of the standard position coordinates may be:

$$UV = ( {U}_{p} , {V}_{p} ) . \qquad ( 11 )$$

UV is configured for indicating the standard position coordinates, Uₚ is configured for indicating the standard horizontal coordinate, and Vₚ is configured for indicating the standard vertical coordinate.

In some embodiments, the color value includes a channel color value of each color channel, and the standardizing the color value to obtain a standard color value may be implemented in the following manner: acquiring a mean and a variance of the channel color value of each color channel of the color image; performing the following processing on the channel color value of each color channel: subtracting the corresponding mean from the channel color value to obtain a reference value; determining a ratio of the reference value to the corresponding variance as a standard channel color value corresponding to the channel color value; and combining the standard channel color values of the color channels into the standard color value.

As an example, an expression of the mean of the channel color values of the color channels of the color image may be:

$$[ {μ}_{r} , {μ}_{g} , {μ}_{b} ] . \qquad ( 12 )$$

μᵣ is configured for indicating a mean of channel color values of an R color channel, μ_{g} is configured for indicating a mean of channel color values of a G color channel, and μ_{b} is configured for indicating a mean of channel color values of a B color channel.

As an example, an expression of the variance of the channel color values of the color channels of the color image may be:

$$[ {σ}_{r} , {σ}_{g} , {σ}_{b} ] . \qquad ( 13 )$$

σᵣ is configured for indicating a variance of the channel color values of the R color channel, σ_{g} is configured for indicating a variance of the channel color values of the G color channel, and σ_{b} is configured for indicating a variance of the channel color values of the B color channel.

As an example, an expression of a standard channel color value of the R color channel may be:

$${R}_{p} = \frac{{r}_{p} - {μ}_{r}}{{σ}_{r}} . \qquad ( 14 )$$

Rₚ is configured for indicating the standard channel color value of the R color channel, rₚ is configured for indicating the channel color value of the R color channel, μᵣ is configured for indicating a mean of the channel color values of the R color channel, and σᵣ is configured for indicating a variance of the channel color values of the R color channel.

As an example, an expression of a standard channel color value of the G color channel may be:

$${G}_{p} = \frac{{g}_{p} - {μ}_{g}}{{σ}_{g}} . \qquad ( 15 )$$

Gₚ is configured for indicating the standard channel color value of the G color channel, gₚ is configured for indicating the channel color value of the G color channel, μ_{g} is configured for indicating a mean of the channel color values of the G color channel, and σ_{g} is configured for indicating a variance of the channel color values of the G color channel.

As an example, an expression of a standard channel color value of the B color channel may be:

$${B}_{p} = \frac{{b}_{p} - {μ}_{b}}{{σ}_{b}} . \qquad ( 16 )$$

Bₚ is configured for indicating the standard channel color value of the B color channel, bₚ is configured for indicating the channel color value of the B color channel, σ_{b} is configured for indicating a variance of the channel color values of the B color channel, and μₚ is configured for indicating a mean of the channel color values of the B color channel.

In this way, the position coordinates and the color value are respectively standardized to obtain the standard position coordinates and the standard color value. The initial depth prediction model is trained based on the standard position coordinates and the standard color value, so that the initial depth prediction model can be more sensitive to standard data, thereby effectively improving the training efficiency of the initial depth prediction model. When the depth information of the second associated pixel is predicted by invoking the trained depth prediction model, because training is performed based on standard data, during application, the position coordinates may be standardized to obtain the standard position coordinates. The color value is standardized to obtain the standard color value, and the depth information of the second associated pixel is predicted based on the standard position coordinates and the standard color value, so that the sensitivity of the depth prediction model to standard data can be efficiently used, thereby effectively improving the accuracy of predicting the depth information of the second associated pixel.

In some embodiments, the depth prediction model includes a parameter conversion layer, a feature extraction layer, a feature fusion layer, and a depth prediction layer.

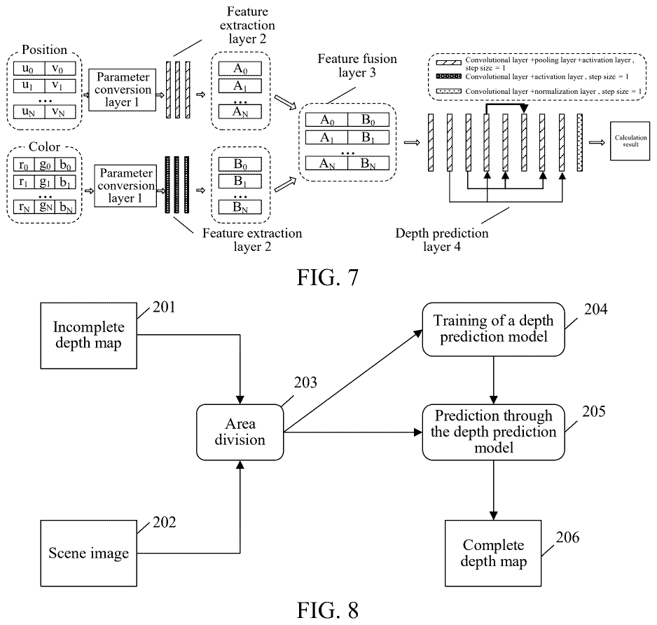

As an example, FIG. 7 is a schematic structural diagram of a depth prediction model according to an embodiment of the present disclosure. The depth prediction model includes a parameter conversion layer 1, a feature extraction layer 2, a feature fusion layer 3, and a depth prediction layer 4. The feature extraction layer 2 includes a convolutional layer, a pooling layer, and an activation layer. The depth prediction layer includes a convolutional layer, a pooling layer, an activation layer, and a normalization layer.

In some embodiments, the predicting the depth information of the second associated pixel based on the standard position coordinates and the standard color value by invoking the depth prediction model to obtain initial depth information of the second associated pixel may be implemented in the following manner: performing parameter conversion on the standard position coordinates and the standard color value by invoking the parameter conversion layer to obtain converted position coordinates and a converted color value; performing feature extraction on the converted position coordinates and the converted color value by invoking the feature extraction layer to obtain a position feature and a color feature; fusing the position feature and the color feature by invoking the feature fusion layer to obtain a fused feature; and predicting the depth information of the second associated pixel based on the fused feature by invoking the depth prediction layer to obtain the initial depth information of the second associated pixel.

In some embodiments, the feature extraction layer may convert the converted position coordinates into a corresponding position feature in a vector form, and convert the converted color value into a corresponding color feature in a vector form.

As an example, referring to FIG. 7, parameter conversion is separately performed on the standard position coordinates and the standard color value by invoking the parameter conversion layer 1 to obtain the converted position coordinates and the converted color value. Feature extraction is separately performed on the converted position coordinates and the converted color value by invoking the feature extraction layer 2 to obtain a position feature (A₀A₁, . . . , A_{N}) and a color feature (B₀B₁, . . . , B_{N}). The position feature and the color feature are fused by invoking the feature fusion layer 3 to obtain a fused feature (A₀B₀A₁B₁, . . . , A_{N}B_{N}). The depth information of the second associated pixel is predicted based on the fused feature by invoking the depth prediction layer 4 to obtain the initial depth information of the second associated pixel.

As an example, to better fit pixel position information and better encode position high-frequency information, parameter conversion may be performed on the standard position coordinates. The converted position coordinates include a converted position horizontal coordinate and a converted position vertical coordinate. An expression of the converted position horizontal coordinate may be:

$$γ ( {u}_{p} ) = [ sin ( {2}^{0} π {u}_{p} ) , cos ( {2}^{0} π {u}_{p} ) , … , sin ( {2}^{L - 1} π {u}_{p} ) , cos ( {2}^{L - 1} π {u}_{p} ) ] . \qquad ( 17 )$$

uₚ is configured for indicating a standard position horizontal coordinate, and γ(uₚ) is configured for indicating the converted position horizontal coordinate.

As an example, an expression of the converted position vertical coordinate may be:

$$γ ( {v}_{p} ) = [ sin ( {2}^{0} π {v}_{p} ) , cos ( {2}^{0} π {v}_{p} ) , … , sin ( {2}^{L - 1} π {v}_{p} ) , cos ( {2}^{L - 1} π {v}_{p} ) ] \qquad ( 18 )$$

γ(Vₚ) is configured for indicating the converted position vertical coordinate, and vₚ is configured for indicating a standard position vertical coordinate.

As an example, an expression of a converted color value of the R color channel may be:

$${r}_{p}^{*} = \frac{{r}_{p}}{{r}_{p} + {g}_{p} + {b}_{p}} . \qquad ( 19 )$$

$${r}_{p}^{*}$$

is configured for indicating the converted color value of the R color channel, rₚ is configured for indicating a standard color value of the R color channel, gₚ is configured for indicating a standard color value of the G color channel, and bₚ is configured for indicating a standard color value of the B color channel.

As an example, an expression of the converted color value of the G color channel may be:

$${g}_{p}^{*} = \frac{{g}_{p}}{{r}_{p} + {g}_{p} + {b}_{p}} . \qquad ( 20 )$$

$${g}_{p}^{*}$$

is configured for indicating the converted color value of the G color channel, rₚ is configured for indicating the standard color value of the R color channel, gₚ is configured for indicating the standard color value of the G color channel, and bₚ is configured for indicating the standard color value of the B color channel.

As an example, an expression of the converted color value of the B color channel may be:

$${b}_{p}^{*} = \frac{{b}_{p}}{{r}_{p} + {g}_{p} + {b}_{p}} . \qquad ( 21 )$$

$${b}_{p}^{*}$$

is configured for indicating the converted color value of the B color channel, rₚ is configured for indicating the standard color value of the R color channel, gₚ is configured for indicating the standard color value of the G color channel, and bₚ is configured for indicating the standard color value of the B color channel.

In some embodiments, the destandardizing the initial depth information to obtain the predicted depth information of the second associated pixel may be implemented in the following manner: determining maximum depth information and minimum depth information from the depth information of the pixels of the first sub-depth image; acquiring a first depth scaling factor corresponding to the maximum depth information and a second depth scaling factor corresponding to the minimum depth information; determining a product of the first depth scaling factor and the maximum depth information as first reference depth information; determining a product of the second depth scaling factor and the minimum depth information as second reference depth information; subtracting the second reference depth information from the first reference depth information to obtain a subtraction result; and determining a product of the initial depth information and the subtraction result as the predicted depth information of the second associated pixel.

In some embodiments, the maximum depth information is maximum depth information in the depth information of the pixels of the first sub-depth image, and the minimum depth information is minimum depth information in the depth information of the pixels of the first sub-depth image.

As an example, an expression of the predicted depth information of the second associated pixel may be:

$${d}_{q}^{*} = {d}_{p} \times ( {d}_{max}^{*} - {d}_{min}^{*} ) . \qquad ( 22 )$$

$${d}_{max}^{*}$$

is configured for indicating the first reference depth information,

$${d}_{min}^{*}$$

is configured for indicating the second reference depth information, dₚ is configured for indicating the initial depth information, and

$${d}_{q}^{*}$$

is configured for indicating the predicted depth information of the second associated pixel.

As an example, an expression of the first reference depth information may be:

$${d}_{max}^{*} = ( 1 + {α}_{max} ) {d}_{max} . \qquad ( 23 )$$

$${d}_{max}^{*}$$

is configured for indicating the first reference depth information, αₘₐₓ is configured for indicating the first depth scaling factor, and dₘₐₓ is configured for indicating a maximum value in the predicted depth information of the first associated pixels.

As an example, an expression of the second reference depth information may be:

$${d}_{min}^{*} = ( 1 - {α}_{min} ) {d}_{min} . \qquad ( 24 )$$

$${d}_{min}^{*}$$

is configured for indicating the second reference depth information, αₘᵢₙ is configured for indicating the second depth scaling factor, and dₘᵢₙ is configured for indicating a minimum value in the predicted depth information of the first associated pixels.

Operation 1033: Assign a value to a corresponding second pixel in the second sub-depth image based on the predicted depth information of each second associated pixel, and determine the second sub-depth image with the values assigned as the third sub-depth image.

In some embodiments, the second associated pixel is in a one-to-one correspondence with the second pixel in the second sub-depth image. Predicted depth information of the corresponding second associated pixel is assigned to each second pixel in the second sub-depth image, and the second sub-depth image with the values assigned is determined as the third sub-depth image, so that the third sub-depth image has depth information and has image content kept consistent with that of the second sub-depth image.

Operation 104: Fuse the first sub-depth image and the third sub-depth image to obtain a complete depth image corresponding to the color image.

In some embodiments, operation 104 may be implemented in the following manner: concatenating the first sub-depth image and the third sub-depth image according to a position relationship between the first sub-depth image and the second sub-depth image in the depth image to obtain the complete depth image corresponding to the color image.

In this way, a first sub-depth image that has depth information, a second sub-depth image that does not have depth information, a first color area that is in a color image and corresponds to the first sub-depth image, and a second color area that is in the color image and corresponds to the second sub-depth image are acquired, depth information of each pixel in the second color area in the color image is predicted through a depth prediction model to obtain a third sub-depth image, and the first sub-depth image and the third sub-depth image are fused to obtain a complete depth image corresponding to the color image. In this case, training of the depth prediction model, training is performed by using the pixels in the first color area in the color image as samples, and the depth prediction model predicts the depth information of each pixel in the second color area in the color image. The first color area and the second color area are both from the same color image. Therefore, regardless of an application scenario in which the color image belongs, through the first sub-depth image that corresponds to the color image and has depth information, the depth information of the second sub-depth image that does not have depth information can be predicted, so that in a process of generating a depth image, dependency on an application scenario is significantly reduced, thereby effectively decoupling a strong scenario coupling relationship between training samples and a generated depth image in a training process and an application process, and effectively improving scenario universality of generating a depth image.

An exemplary application of the embodiments of the present disclosure in an actual application scenario of generating a depth image is described below.

An incomplete depth map with a missing area is completed based on the incomplete depth map and an associated reference image, to ensure that each pixel in the reference image has scene depth information. In the method for generating a depth image provided in the embodiments of the present disclosure, first, area division is performed on an incomplete depth map and a reference image to obtain a known scene area and a to-be-filled area. Next, a lightweight multilayer neural network model is trained to encode the known scene area. The model uses colors and two-dimensional pixel coordinates of the known scene area as inputs, and outputs predicted depth information of the known scene area. After model training ends, the colors and two-dimensional pixel coordinates of the to-be-filled area are used as inputs, so that depth information of the to-be-filled area can be obtained, to form a complete completed depth map.

In some embodiments, FIG. 8 is a schematic flowchart 5 of a method for generating a depth image according to an embodiment of the present disclosure. The method for generating a depth image provided in the embodiments of the present disclosure may be implemented through operation 201 to operation 206 shown in FIG. 8.

Operation 201: Obtain an incomplete depth map.

In some embodiments, the incomplete depth map may be a depth image corresponding to the color image described above. The incomplete depth map includes a first sub-depth image and a second sub-depth image. The first sub-depth image and the second sub-depth image are obtained by dividing a depth image corresponding to a color image, the first sub-depth image corresponds to a first color area in the color image, and the second sub-depth image corresponds to a second color area in the color image.

Operation 202: Acquire a scene image.

In some embodiments, the scene image may be a color image described above, and the color image may be an image in an RGB color mode. The RGB color mode is a color standard in the industry, and obtains various colors by changing channels of three color channels R, G, and B and through superimposition of the channels. RGB represents colors of the channels R, G, and B. The standard almost includes all colors perceptible to human eyesight, and is one of the most widely used color systems.

Operation 203: Perform area division on the scene image and the incomplete depth map.

In some embodiments, the performing area division on the scene image (i.e., the color image mentioned above) is a process of dividing the color area of the color image into the first color area and the second color area. The first color area in the color image corresponds to the first sub-depth image, and the second color area in the color image corresponds to the second sub-depth image.

The performing area division on the incomplete depth map is a process of dividing the incomplete depth map into the first sub-depth image and the second sub-depth image, and the following processing may be separately performed on each pixel of the depth image: determining the pixel as a first pixel when the pixel has the depth information; and determining the pixel as a second pixel when the pixel does not have the depth information; categorizing an area formed by the first pixels in the depth image as the first sub-depth image; and categorizing an area formed by the second pixels in the depth image as the second sub-depth image.

Operation 204: Train a depth prediction model.

In some embodiments, the depth prediction model is obtained through training by taking pixels in the first color area in the color image as samples and taking corresponding depth information in the first sub-depth image as a label.

Operation 205: Perform prediction through the depth prediction model.

In some embodiments, prediction may be performed through the depth prediction model in the following manner: acquiring a first sub-depth image that has depth information and a second sub-depth image that does not have depth information, the first sub-depth image and the second sub-depth image being obtained by dividing a depth image corresponding to a color image, the first sub-depth image corresponding to a first color area in the color image, and the second sub-depth image corresponding to a second color area in the color image; predicting depth information of each pixel in the second color area in the color image through the depth prediction model to obtain a third sub-depth image corresponding to the second color area; and fusing the first sub-depth image and the third sub-depth image to obtain a complete depth image corresponding to the color image.

Operation 206: Obtain a complete depth map.

In some embodiments, it is assumed that a given incomplete depth map is D₀, and a corresponding scene image with equal resolutions is I₀ (also referred to as a reference image). First, area division is performed according to whether depth information of pixels of D₀ is known to form a known scene area and a to-be-filled area. Next, information of the known scene area is configured for driving a scene encoding network (a depth prediction model) to perform scene encoding, scene information of the known scene area is fully understood. Next, a scene depth corresponding to each pixel in the to-be-filled area is predicted based on the trained scene encoding network, and is then fused with the information of the known scene area to form a complete depth map.

In some embodiments, area division is performed first. It is assumed that a color value corresponding to a pixel p with a position of (uₚ, vₚ) in the scene image D₀ is [rₚ, gₚ, bₚ]. If a scene depth

$${D}_{0}^{p}$$

corresponding to the pixel is known, the information is combined into a known scene sample

$$[ {u}_{p} , {v}_{p} , {r}_{p} , {g}_{p} , {b}_{p} , {D}_{0}^{p} ] .$$

If the scene depth of the pixel p is unknown, i.e., is missing, the information is combined into a to-be-filled sample [uₚ, vₚ, rₚ, gₚ, bₚ]. After the foregoing process, all pixels of D₀ and I₀ are categorized as known scene samples or to-be-filled samples.

In some embodiments, samples are then standardized: After sample categorization, standardization needs to be performed on all samples, the standardization including pixel position standardization, pixel color standardization, and depth standardization. The pixel position standardization and the pixel color standardization need to be performed on all the samples. The depth standardization needs to be additionally performed on known scene samples. Assuming that image resolutions of D₀ and I₀ are both H×W, for position information [uₚ, vₚ] in the sample p, the position standardization is as follows:

$${u}_{pb} = \frac{{u}_{p}}{H - 1} , {v}_{pb} = \frac{{v}_{p}}{W - 1} . \qquad ( 25 )$$

u_{pb} is configured for indicating standardized horizontal coordinate position information of the sample p, v_{pb} is configured for indicating standardized vertical coordinate position information of the sample p, uₚ is configured for indicating horizontal coordinate position information of the sample p, vₚ is configured for indicating vertical coordinate position information of the sample p, H is configured for indicating a horizontal coordinate standardization parameter, and W is configured for indicating a vertical coordinate standardization parameter.

Assuming that a mean and a variance of colors of all the pixels in I₀ are respectively as follows: [μᵣ, μ_{g}, μ_{b}] and [σᵣ, σ_{g}, σ_{b}]. For color information [rₚ, gₚ, bₚ] in any sample p, the color standardization is as follows:

$${r}_{pb} = \frac{{r}_{p} - {μ}_{r}}{{σ}_{r}} , {g}_{pb} = \frac{{g}_{p} - {μ}_{g}}{{σ}_{g}} , {b}_{pb} = \frac{{b}_{p} - {μ}_{b}}{{σ}_{b}} . \qquad ( 26 )$$

r_{pb} is configured for indicating color information obtained by performing color standardization of the R channel, g_{pb} is configured for indicating color information obtained by performing color standardization of the G channel, b_{pb} is configured for indicating color information obtained by performing color standardization of the G channel, rₚ is configured for indicating color information of the R channel, gₚ is configured for indicating color information of the G channel, bₚ is configured for indicating color information of the B channel, μᵣ and σᵣ are color standardization parameters of the R channel, μ_{g} and σ_{g} are configured for indicating color standardization parameters of the G channel, and uₚ and σ_{b} are configured for indicating color standardization parameters of the B channel.

Assuming that a minimum value and a maximum value of known depths in Do are respectively dₘᵢₙ and dₘₐₓ, standardization of depth information

$${D}_{0}^{p}$$

of a known scene sample is as follows:

$${d}_{max}^{*} = ( 1 + {α}_{max} ) {d}_{max} , \qquad ( 27 )$$

$${d}_{min}^{*} = ( 1 - {α}_{min} ) {d}_{min} , and \qquad ( 28 )$$

$${D}_{0}^{p} = \frac{{D}_{0}^{p}}{{d}_{max}^{*} - {d}_{min}^{*}} . \qquad ( 29 )$$

αₘₐₓ and αₘᵢₙ are respectively scene depth scaling factors, may be selected according to an actual case, and are generally set to αₘₐₓ=0.1 and αₘᵢₙ=0.2.

In some embodiments, for scene encoding, after known scene samples are standardized, scene encoding understanding may be performed through the depth prediction model, and a scene encoding process may be understood as a training process of the depth prediction model. It is assumed that for a known scene sample

$$[ {u}_{p} , {v}_{p} , {r}_{p} , {g}_{p} , {b}_{p} , {D}_{0}^{p} ] ,$$

an input of the depth prediction model is [uₚ, vₚ, rₚ, gₚ, bₚ], an output is a predicted depth value dₚ, and a loss function is defined as follows:

$$Loss = {\sum }_{p ∈ Φ} \vert {d}_{p} - {D}_{0}^{p} \vert . \qquad ( 30 )$$

Φ is a standardized sample set. Training may be completed by using a standard gradient descent method to obtain a scene encoding network that may be configured for depth prediction.

In some embodiments, for depth completion, a depth prediction model of which scene encoding has been completed is marked as T. For any to-be-filled sample [u_{q}, v_{q}, r_{q}, g_{q}, b_{q}] of the to-be-filled area, a standardized depth value d_{q} corresponding to the to-be-filled sample may be calculated:

$${d}_{p} = T ( {u}_{q} , {v}_{q} , {r}_{q} , {g}_{q} , {b}_{q} ) . \qquad ( 31 )$$

Next, depth destandardization is performed to obtain a scene depth true value

$${d}_{q}^{*}$$

of the to-be-filled area:

$${d}_{q}^{*} = {d}_{p} \times ( {d}_{max}^{*} - {d}_{min}^{*} ) . \qquad ( 32 )$$

In some embodiments, for depth fusion, after depth true values of all pixels of the to-be-filled area are obtained, the depth true values are directly combined with known scene depths to obtain the complete depth map. Next, median filtering is performed on the obtained complete depth map to improve continuity between the filled depth information and original known depths to obtain a completed depth map with higher quality.

In some embodiments, referring to FIG. 7, for a structure of a depth prediction model shown in FIG. 7, network inputs are a coordinate value [uₚ, vₚ] and a color value [rₚ, gₚ, bₚ] of a to-be-calculated pixel p, and an output is a scene depth value corresponding to the pixel p. First, the coordinate value and the color value that are inputted are respectively encoded; then a coordinate feature and a color feature are respectively extracted through corresponding feature extraction networks; and next, the extracted coordinate feature and color feature are concatenated to synthesize a new feature vector, and the feature vector is fed as an input into a nine-layer neural network to calculate a corresponding depth value.

In some embodiments, for position encoding, to better fit pixel position information and better encode position high-frequency information, a pixel coordinate value [uₚ, vₚ] is encoded as follows:

$$γ ( {u}_{p} ) = [ sin ( {2}^{0} π {u}_{p} ) , cos ( {2}^{0} π {u}_{p} ) , … , sin ( {2}^{L - 1} π {u}_{p} ) , cos ( {2}^{L - 1} π {u}_{p} ) ] , and \qquad ( 33 )$$

$$γ ( {v}_{p} ) = [ sin ( {2}^{0} π {v}_{p} ) , cos ( {2}^{0} π {v}_{p} ) , … , sin ( {2}^{L - 1} π {v}_{p} ) , cos ( {2}^{L - 1} π {v}_{p} ) ] . \qquad ( 34 )$$

A 4 L-dimensional position code vector [γ(uₚ), γ(vₚ)] is further obtained, and generally, L=10.

In some embodiments, for color encoding, to reduce impacts of scene illumination and picture shadow on a scene image, the color value [rₚ, gₚ, bₚ] is encoded as follows:

$${r}_{p}^{*} = \frac{{r}_{p}}{{r}_{p} + {g}_{p} + {b}_{p}} , \qquad ( 35 )$$

$${g}_{p}^{*} = \frac{{g}_{p}}{{r}_{p} + {g}_{p} + {b}_{p}} , and \qquad ( 36 )$$

$${b}_{p}^{*} = \frac{{b}_{p}}{{r}_{p} + {g}_{p} + {b}_{p}} . \qquad ( 37 )$$

A new three-dimensional color code

$$[ {r}_{p}^{*} , {g}_{p}^{*} , {b}_{p}^{*} ]$$

is obtained.

In some embodiments, for position feature extraction, a position feature extraction module is a three-layer one-dimensional convolutional network, an input is a 4 L-dimensional position code vector [γ(uₚ), γ(Vₚ)], and an output is a 128-dimensional position feature vector. Input feature dimensions of three one-dimensional convolutional layers are respectively 4 L, 128, and 128, are all configured with an instance normalization layer and a ReLU activation function.

In some embodiments, for color feature extraction: A color feature extraction module is a three-layer one-dimensional convolutional network, an input is a three-dimensional color code vector

$$[ {r}_{p}^{*} , {g}_{p}^{*} , {b}_{p}^{*} ] ,$$

and an output is a 128-dimensional position feature vector. Input feature dimensions of three one-dimensional convolutional layers are respectively 3, 64, and 128, are all configured with a ReLU activation function.

In some embodiments, for scene depth calculation, a scene depth module is responsible for the scene depth calculation, and the module takes a position feature and a color feature as input and outputs a scene depth at a corresponding position. The module is formed by nine one-dimensional convolutional layers, an input feature dimension of each layer is 256, the first eight layers are all configured with an instance normalization layer and a ReLU activation function, and an activation function in the last layer is a sigmoid function. In addition, a calculation result of the second layer is respectively added to results of the third layer and the seventh layer for use as inputs of the fourth layer and the eighth layer, a calculation result of the third layer is respectively added to results of the fourth layer and the sixth layer for use as inputs of the fifth layer and the seventh layer, and a calculation result of the fourth layer is added to a result of the fifth layer for use as a convolution input of the sixth layer. It is assumed that feature vectors obtained from a sample

$$[ γ ( {u}_{p} ) , γ ( {v}_{p} ) , {r}_{p}^{*} , {g}_{p}^{*} , {b}_{p}^{*} ]$$

passing through the position feature extraction module and the color feature extraction module are respectively Aₚ and Bₚ. The module first concatenates Aₚ and Bₚ and then feeds a concatenated result to a convolutional network for calculation to obtain a corresponding depth value.

In this way, through the method for generating a depth image provided in the embodiments of the present disclosure, universality of a depth completion technique can be greatly improved. In the embodiments of the present disclosure, a depth completion task can be completed by using only a single incomplete depth map and a corresponding scene image, and therefore the method can be applied to a completion task for a depth map that is in any scene or acquired by any device, thereby greatly improving the application scope of the algorithm. Algorithm costs are reduced: In the embodiments of the present disclosure, large-scale labeled data does not need to be collected in advance to train a neural network model, thereby avoiding high data labeling costs and model training costs.

In this way, a first sub-depth image that has depth information, a second sub-depth image that does not have depth information, a first color area that is in a color image and corresponds to the first sub-depth image, and a second color area that is in the color image and corresponds to the second sub-depth image are acquired, depth information of each pixel in the second color area in the color image is predicted through a depth prediction model to obtain a third sub-depth image, and the first sub-depth image and the third sub-depth image are fused to obtain a complete depth image corresponding to the color image. In this case, training of the depth prediction model, training is performed by using the pixels in the first color area in the color image as samples, and the depth prediction model predicts the depth information of each pixel in the second color area in the color image. The first color area and the second color area are both from the same color image. Therefore, regardless of an application scenario in which the color image belongs, through the first sub-depth image that corresponds to the color image and has depth information, the depth information of the second sub-depth image that does not have depth information can be predicted, so that in a process of generating a depth image, dependency on an application scenario is significantly reduced, thereby effectively decoupling a strong scenario coupling relationship between training samples and a generated depth image in a training process and an application process, and effectively improving scenario universality of generating a depth image.

In embodiments of the present disclosure, related data such as depth images are involved. When the embodiments of the present disclosure are used in specific products or technologies, user permissions or agreements need to be obtained, and the collection, use, and processing of relevant data need to comply with the relevant laws, regulations, and standards of the relevant countries and regions.

An exemplary structure of the apparatus 455 for generating a depth image implemented as software modules provided in the embodiments of the present disclosure continues to be described below. In some embodiments, as shown in FIG. 2, the software modules in the apparatus 455 for generating a depth image stored in the memory 450 may include: the image acquisition module 4551, configured to acquire a first sub-depth image that has depth information and a second sub-depth image that does not have depth information, the first sub-depth image and the second sub-depth image being obtained by dividing a depth image corresponding to a color image, the first sub-depth image corresponding to a first color area in the color image, and the second sub-depth image corresponding to a second color area in the color image; the model acquisition module 4552, configured to acquire a depth prediction model, the depth prediction model being obtained through training by taking pixels in the first color area in the color image as samples and taking corresponding depth information in the first sub-depth image as a label; the prediction module 4553, configured to predict depth information of each pixel in the second color area in the color image through the depth prediction model to obtain a third sub-depth image corresponding to the second color area; and the fusion module 4554, configured to fuse the first sub-depth image and the third sub-depth image to obtain a complete depth image corresponding to the color image.

In some embodiments, the image acquisition module 4551 is further configured to: acquire the depth image corresponding to the color image, and perform the following processing on each pixel of the depth image: determining the pixel as a first pixel when the pixel has the depth information; determining the pixel as a second pixel when the pixel does not have the depth information; categorizing an area formed by the first pixels in the depth image as the first sub-depth image; and categorizing an area formed by the second pixels in the depth image as the second sub-depth image.

In some embodiments, the model acquisition module 4552 is further configured to: acquire an initial depth prediction model; determine each pixel in the first color area as a first associated pixel; and perform the following processing on each first associated pixel: acquiring position coordinates of the first associated pixel in the first color area and a color value of the first associated pixel; predicting depth information of the first associated pixel based on the position coordinates and the color value by invoking the initial depth prediction model to obtain predicted depth information of the first associated pixel; and training the initial depth prediction model based on the predicted depth information of the first associated pixels and the corresponding depth information in the first sub-depth image to obtain the depth prediction model.

In some embodiments, the model acquisition module 4552 is further configured to: standardize the position coordinates to obtain standard position coordinates; standardize the color value to obtain a standard color value; and predict the depth information of the first associated pixel based on the standard position coordinates and the standard color value by invoking the initial depth prediction model to obtain the predicted depth information of the first associated pixel; and the model acquisition module is further configured to: standardize the depth information of each pixel in the first sub-depth image to obtain standard depth information; and train the initial depth prediction model based on the predicted depth information of the first associated pixels and the corresponding standard depth information in the first sub-depth image to obtain the depth prediction model.

In some embodiments, the model acquisition module 4552 is further configured to: perform the following processing on each first associated pixel: determining, in the first sub-depth image, a first pixel corresponding to the first associated pixel, and acquiring standard depth information of the first pixel; determining a difference between the standard depth information of the first pixel and the predicted depth information of the first associated pixel as a first loss value of the first associated pixel; summing the first loss values of the first associated pixels to obtain a summed loss value; and training the initial depth prediction model based on the summed loss value to obtain the depth prediction model.

In some embodiments, the prediction module 4553 is further configured to: determine each pixel in the second color area as a second associated pixel; and perform the following processing on each second associated pixel: acquiring position coordinates of the second associated pixel in the second color area and a color value of the second associated pixel; predicting depth information of the second associated pixel based on the position coordinates and the color value by invoking the depth prediction model to obtain predicted depth information of the second associated pixel; and assigning a value to a corresponding second pixel in the second sub-depth image based on the predicted depth information of each second associated pixel, and determining the second sub-depth image with the values assigned as the third sub-depth image.

In some embodiments, the prediction module 4553 is further configured to: standardize the position coordinates to obtain standard position coordinates; standardize the color value to obtain a standard color value; predict the depth information of the second associated pixel based on the standard position coordinates and the standard color value by invoking the depth prediction model to obtain initial depth information of the second associated pixel; and destandardize the initial depth information to obtain the predicted depth information of the second associated pixel.

In some embodiments, the prediction module 4553 is further configured to: acquire a first pixel quantity in a horizontal axis direction and a second pixel quantity in a vertical axis direction of the color image; subtract 1 from the first pixel quantity to obtain a first reference quantity, and subtract 1 from the second pixel quantity to obtain a second reference quantity; determine a ratio of the horizontal coordinate to the first reference quantity as a standard horizontal coordinate; determine a ratio of the vertical coordinate to the second reference quantity as a standard vertical coordinate; and combine the standard horizontal coordinate and the standard vertical coordinate into the standard position coordinates.

In some embodiments, the prediction module 4553 is further configured to: acquire a mean and a variance of the channel color value of each color channel of the color image; and perform the following processing on the channel color value of each color channel: subtracting the corresponding mean from the channel color value to obtain a reference value; determining a ratio of the reference value to the corresponding variance as a standard channel color value corresponding to the channel color value; and combining the standard channel color values of the color channels into the standard color value.

In some embodiments, the depth prediction model includes a parameter conversion layer, a feature extraction layer, a feature fusion layer, and a depth prediction layer; and the prediction module 4553 is further configured to: perform parameter conversion separately on the standard position coordinates and the standard color value by invoking the parameter conversion layer to obtain the converted position coordinates and the converted color value; perform feature extraction separately on the converted position coordinates and the converted color value by invoking the feature extraction layer to obtain a position feature and a color feature; fuse the position feature and the color feature by invoking the feature fusion layer to obtain a fused feature; and predict the depth information of the second associated pixel based on the fused feature by invoking the depth prediction layer to obtain the initial depth information of the second associated pixel.

In some embodiments, the prediction module 4553 is further configured to: determine maximum depth information and minimum depth information from the depth information of the pixels of the first sub-depth image; acquire a first depth scaling factor corresponding to the maximum depth information and a second depth scaling factor corresponding to the minimum depth information; determine a product of the first depth scaling factor and the maximum depth information as first reference depth information; determine a product of the second depth scaling factor and the minimum depth information as second reference depth information; subtract the second reference depth information from the first reference depth information to obtain a subtraction result; and determine a product of the initial depth information and the subtraction result as the predicted depth information of the second associated pixel.

Embodiments of the present disclosure provide a computer program product, the computer program product including a computer program or computer-executable instructions, the computer program or the computer-executable instructions being stored in a computer-readable storage medium. A processor of an electronic device reads the computer-executable instructions from the computer-readable storage medium, and the processor executes the computer-executable instructions, to cause the electronic device to perform the foregoing method for generating a depth image provided in the embodiments of the present disclosure.

Embodiments of the present disclosure provide a computer-readable storage medium storing computer-executable instructions. The computer-executable instructions, when executed by a processor, causes the processor to perform the method for generating a depth image provided in the embodiments of the present disclosure, for example, the method for generating a depth image shown in FIG. 3.

In some embodiments, the computer-readable storage medium may be a memory such as a ROM, a RAM, an erasable programmable ROM (EPROM), an electrically erasable programmable ROM (EEPROM), a flash memory, a magnetic surface memory, an optical disc, or a CD-ROM; or may be various devices including one of or any combination of the foregoing memories.

In some embodiments, the computer-executable instructions may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

In an example, the computer-executable instructions may be deployed to be executed on one electronic device, or executed on a plurality of electronic devices located at one place, or executed on a plurality of electronic devices that are distributed at a plurality of places and are interconnected by a communication network.

In summary, the embodiments of the present disclosure have the following beneficial effects.

(1) A first sub-depth image that has depth information, a second sub-depth image that does not have depth information, a first color area that is in a color image and corresponds to the first sub-depth image, and a second color area that is in the color image and corresponds to the second sub-depth image are acquired, depth information of each pixel in the second color area in the color image is predicted through a depth prediction model to obtain a third sub-depth image, and the first sub-depth image and the third sub-depth image are fused to obtain a complete depth image corresponding to the color image. In this case, training of the depth prediction model, training is performed by using the pixels in the first color area in the color image as samples, and the depth prediction model predicts the depth information of each pixel in the second color area in the color image. The first color area and the second color area are both from the same color image. Therefore, regardless of an application scenario in which the color image belongs, through the first sub-depth image that corresponds to the color image and has depth information, the depth information of the second sub-depth image that does not have depth information can be predicted, so that in a process of generating a depth image, dependency on an application scenario is significantly reduced, thereby effectively decoupling a strong scenario coupling relationship between training samples and a generated depth image in a training process and an application process, and effectively improving scenario universality of generating a depth image.

(2) The depth image (the depth image corresponding to the color image) lacking depth information is divided into the first sub-depth image and the second sub-depth image according to whether depth information exists, to subsequently train an initial depth prediction model based on the first color area in the color image corresponding to the first sub-depth image that has depth information. The depth information of the second sub-depth image is predicted by using a trained depth prediction model. Because a training sample (the first sub-depth image) and a to-be-predicted image (the second sub-depth image) both come from the depth image corresponding to the color image, the trained depth prediction model is more sensitive to the second sub-depth image. The depth prediction model is trained in real time in a prediction process, thereby effectively improving the universality of the trained depth prediction model.

(3) In this way, the position coordinates and the color value are respectively standardized to obtain the standard position coordinates and the standard color value. The initial depth prediction model is trained based on the standard position coordinates and the standard color value, so that the initial depth prediction model can be more sensitive to standard data, thereby effectively improving the training efficiency of the initial depth prediction model.

(4) In this way, the position coordinates and the color value are respectively standardized to obtain the standard position coordinates and the standard color value. The initial depth prediction model is trained based on the standard position coordinates and the standard color value, so that the initial depth prediction model can be more sensitive to standard data, thereby effectively improving the training efficiency of the initial depth prediction model. When the depth information of the second associated pixel is predicted by invoking the trained depth prediction model, because training is performed based on standard data, during application, the position coordinates may be standardized to obtain the standard position coordinates. The color value is standardized to obtain the standard color value, and the depth information of the second associated pixel is predicted based on the standard position coordinates and the standard color value, so that the sensitivity of the depth prediction model to standard data can be efficiently used, thereby effectively improving the accuracy of predicting the depth information of the second associated pixel.

(5) Through the method for generating a depth image provided in the embodiments of the present disclosure, universality of a depth completion technique can be greatly improved. In the embodiments of the present disclosure, a depth completion task can be completed by using only a single incomplete depth map and a corresponding scene image, and therefore the method can be applied to a completion task for a depth map that is in any scene or acquired by any device, thereby greatly improving the application scope of the algorithm. Algorithm costs are reduced: In the embodiments of the present disclosure, large-scale labeled data does not need to be collected in advance to train a neural network model, thereby avoiding high data labeling costs and model training costs.

(6) The predicted depth information of the first associated pixel is obtained by performing prediction based on the standard position coordinates and the standard color value. Therefore, the predicted depth information of the first associated pixel has a standardized format. Therefore, the depth information of each pixel in the first sub-depth image may be standardized to obtain the standard depth information, so that the standard depth information and the predicted depth information are in the same standardized format. Further, the initial depth prediction model is trained by using the predicted depth information of the first associated pixels in the standardized format and the corresponding standard depth information in the first sub-depth image to obtain the depth prediction model, so that the obtained depth prediction model can be more sensitive to standard data, thereby effectively improving the training efficiency of an initial depth prediction model.

The foregoing descriptions are merely examples of the present disclosure and are not intended to limit the scope of protection of the present disclosure. Any modification, equivalent replacement, or improvement made without departing from the spirit and range of the present disclosure shall fall within the scope of protection of the present disclosure.

What is claimed is:

1. A method for generating a depth image, applied to an electronic device, comprising:
acquiring a first sub-depth image that has depth information and a second sub-depth image that does not have depth information, wherein the first sub-depth image and the second sub-depth image are obtained by dividing a depth image corresponding to a color image, wherein the first sub-depth image corresponds to a first color area in the color image, and wherein the second sub-depth image corresponds to a second color area in the color image;
acquiring a depth prediction model, wherein the depth prediction model is obtained through training by taking pixels in the first color area in the color image as samples and taking corresponding depth information in the first sub-depth image as a label;
predicting depth information of each pixel in the second color area in the color image through the depth prediction model to obtain a third sub-depth image corresponding to the second color area; and
fusing the first sub-depth image and the third sub-depth image to obtain a complete depth image corresponding to the color image.

2. The method according to claim 1, wherein the acquiring the first sub-depth image that has depth information and the second sub-depth image that does not have depth information comprises:
acquiring the depth image corresponding to the color image, and performing the following processing on each pixel of the depth image:
determining the pixel as a first pixel based on the pixel having the depth information;
determining the pixel as a second pixel based on the pixel not having the depth information;
categorizing an area formed by first pixels in the depth image as the first sub-depth image; and
categorizing an area formed by second pixels in the depth image as the second sub-depth image.

3. The method according to claim 1, wherein the acquiring the depth prediction model comprises:
acquiring an initial depth prediction model;
determining each pixel in the first color area as a first associated pixel; and
performing the following processing on each first associated pixel:
acquiring position coordinates of the first associated pixel in the first color area and a color value of the first associated pixel;
predicting depth information of the first associated pixel based on the position coordinates and the color value by invoking the initial depth prediction model to obtain predicted depth information of the first associated pixel; and
training the initial depth prediction model based on predicted depth information of first associated pixels and corresponding depth information in the first sub-depth image to obtain the depth prediction model.

4. The method according to claim 3, wherein the predicting the depth information of the first associated pixel based on the position coordinates and the color value by invoking the initial depth prediction model to obtain the predicted depth information of the first associated pixel comprises:
standardizing the position coordinates to obtain standard position coordinates;
standardizing the color value to obtain a standard color value; and
predicting the depth information of the first associated pixel based on the standard position coordinates and the standard color value by invoking the initial depth prediction model to obtain the predicted depth information of the first associated pixel; and
wherein the training the initial depth prediction model based on the predicted depth information of the first associated pixels and the corresponding depth information in the first sub-depth image to obtain the depth prediction model comprises:
standardizing depth information of each pixel in the first sub-depth image to obtain standard depth information; and
training the initial depth prediction model based on predicted depth information of the first associated pixels and corresponding standard depth information in the first sub-depth image to obtain the depth prediction model.

5. The method according to claim 4, wherein the training the initial depth prediction model based on the predicted depth information of the first associated pixels and the corresponding standard depth information in the first sub-depth image to obtain the depth prediction model comprises:
performing the following processing on each first associated pixel:
determining, in the first sub-depth image, a first pixel corresponding to the first associated pixel, and
acquiring standard depth information of the first pixel;
determining a difference between the standard depth information of the first pixel and the predicted depth information of the first associated pixel as a first loss value of the first associated pixel;
summing first loss values of the first associated pixels to obtain a summed loss value; and
training the initial depth prediction model based on the summed loss value to obtain the depth prediction model.

6. The method according to claim 1, wherein the predicting the depth information of each pixel in the second color area in the color image through the depth prediction model to obtain the third sub-depth image corresponding to the second color area comprises:
determining each pixel in the second color area as a second associated pixel; and
performing the following processing on each second associated pixel:
acquiring position coordinates of the second associated pixel in the second color area and a color value of the second associated pixel;
predicting depth information of the second associated pixel based on the position coordinates and the color value by invoking the depth prediction model to obtain predicted depth information of the second associated pixel; and
assigning a value to a corresponding second pixel in the second sub-depth image based on predicted depth information of each second associated pixel; and
determining the second sub-depth image with values assigned as the third sub-depth image.

7. The method according to claim 6, wherein the predicting the depth information of the second associated pixel based on the position coordinates and the color value by invoking the depth prediction model to obtain the predicted depth information of the second associated pixel comprises:
standardizing the position coordinates to obtain standard position coordinates;
standardizing the color value to obtain a standard color value; and
predicting the depth information of the second associated pixel based on the standard position coordinates and the standard color value by invoking the depth prediction model to obtain initial depth information of the second associated pixel; and
destandardizing the initial depth information to obtain the predicted depth information of the second associated pixel.

8. The method according to claim 7, wherein the position coordinates comprise a horizontal coordinate and a vertical coordinate, and wherein the standardizing the position coordinates to obtain the standard position coordinates comprises:
acquiring a first pixel quantity in a horizontal axis direction and a second pixel quantity in a vertical axis direction of the color image;
subtracting 1 from the first pixel quantity to obtain a first reference quantity, and subtracting 1 from the second pixel quantity to obtain a second reference quantity;
determining a ratio of the horizontal coordinate to the first reference quantity as a standard horizontal coordinate; determining a ratio of the vertical coordinate to the second reference quantity as a standard vertical coordinate; and
combining the standard horizontal coordinate and the standard vertical coordinate into the standard position coordinates.

9. The method according to claim 7, wherein the color value comprises a channel color value of each color channel, and the standardizing the color value to obtain the standard color value comprises:
performing the following processing on the channel color value of each color channel:
acquiring a mean and a variance of the channel color value of the color channel;
subtracting the mean from the channel color value to obtain a reference value;
determining a ratio of the reference value to the variance as a standard channel color value corresponding to the channel color value; and
combining standard channel color values of color channels into the standard color value.

10. The method according to claim 7, wherein the depth prediction model comprises a parameter conversion layer, a feature extraction layer, a feature fusion layer, and a depth prediction layer; and
wherein the predicting the depth information of the second associated pixel based on the standard position coordinates and the standard color value by invoking the depth prediction model to obtain the initial depth information of the second associated pixel comprises:
performing parameter conversion on the standard position coordinates and the standard color value by invoking the parameter conversion layer to obtain converted position coordinates and a converted color value;
performing feature extraction on the converted position coordinates and the converted color value by invoking the feature extraction layer to obtain a position feature and a color feature;
fusing the position feature and the color feature by invoking the feature fusion layer to obtain a fused feature; and
predicting the depth information of the second associated pixel based on the fused feature by invoking the depth prediction layer to obtain the initial depth information of the second associated pixel.

11. The method according to claim 7, wherein the destandardizing the initial depth information to obtain the predicted depth information of the second associated pixel comprises:
determining maximum depth information and minimum depth information from depth information of pixels of the first sub-depth image;
acquiring a first depth scaling factor corresponding to the maximum depth information and a second depth scaling factor corresponding to the minimum depth information;
determining a product of the first depth scaling factor and the maximum depth information as first reference depth information; determining a product of the second depth scaling factor and the minimum depth information as second reference depth information;
subtracting the second reference depth information from the first reference depth information to obtain a subtraction result; and
determining a product of the initial depth information and the subtraction result as the predicted depth information of the second associated pixel.

12. An electronic device, comprising:
one or more processors; and
memory storing instructions that, when executed by the one or more processors, cause the electronic device to facilitate:
acquiring a first sub-depth image that has depth information and a second sub-depth image that does not have depth information, wherein the first sub-depth image and the second sub-depth image are obtained by dividing a depth image corresponding to a color image, wherein the first sub-depth image corresponds to a first color area in the color image, and wherein the second sub-depth image corresponds to a second color area in the color image;
acquiring a depth prediction model, wherein the depth prediction model is obtained through training by taking pixels in the first color area in the color image as samples and taking corresponding depth information in the first sub-depth image as a label;
predicting depth information of each pixel in the second color area in the color image through the depth prediction model to obtain a third sub-depth image corresponding to the second color area; and
fusing the first sub-depth image and the third sub-depth image to obtain a complete depth image corresponding to the color image.

13. The electronic device according to claim 12, wherein the instructions, when executed by the one or more processors, cause the electronic device to facilitate:
acquiring the depth image corresponding to the color image, and performing the following processing on each pixel of the depth image:
determining the pixel as a first pixel based on the pixel having the depth information;
determining the pixel as a second pixel based on the pixel not having the depth information;
categorizing an area formed by first pixels in the depth image as the first sub-depth image; and
categorizing an area formed by second pixels in the depth image as the second sub-depth image.

14. The electronic device according to claim 12, wherein the instructions, when executed by the one or more processors, cause the electronic device to facilitate:
acquiring an initial depth prediction model;
determining each pixel in the first color area as a first associated pixel; and
performing the following processing on each first associated pixel:
acquiring position coordinates of the first associated pixel in the first color area and a color value of the first associated pixel;
predicting depth information of the first associated pixel based on the position coordinates and the color value by invoking the initial depth prediction model to obtain predicted depth information of the first associated pixel; and
training the initial depth prediction model based on predicted depth information of first associated pixels and corresponding depth information in the first sub-depth image to obtain the depth prediction model.

15. The electronic device according to claim 14, wherein the instructions, when executed by the one or more processors, cause the electronic device to facilitate:
standardizing the position coordinates to obtain standard position coordinates;
standardizing the color value to obtain a standard color value; and
predicting the depth information of the first associated pixel based on the standard position coordinates and the standard color value by invoking the initial depth prediction model to obtain the predicted depth information of the first associated pixel; and
wherein the training the initial depth prediction model based on the predicted depth information of the first associated pixels and the corresponding depth information in the first sub-depth image to obtain the depth prediction model comprises the instructions causing the electronic device to facilitate:
standardizing depth information of each pixel in the first sub-depth image to obtain standard depth information; and
training the initial depth prediction model based on predicted depth information of the first associated pixels and corresponding standard depth information in the first sub-depth image to obtain the depth prediction model.

16. The electronic device according to claim 15, wherein the instructions, when executed by the one or more processors, cause the electronic device to facilitate:
performing the following processing on each first associated pixel:
determining, in the first sub-depth image, a first pixel corresponding to the first associated pixel, and
acquiring standard depth information of the first pixel;
determining a difference between the standard depth information of the first pixel and the predicted depth information of the first associated pixel as a first loss value of the first associated pixel;
summing first loss values of the first associated pixels to obtain a summed loss value; and
training the initial depth prediction model based on the summed loss value to obtain the depth prediction model.

17. The electronic device according to claim 12, wherein the instructions, when executed by the one or more processors, cause the electronic device to facilitate:
determining each pixel in the second color area as a second associated pixel; and
performing the following processing on each second associated pixel:
acquiring position coordinates of the second associated pixel in the second color area and a color value of the second associated pixel;
predicting depth information of the second associated pixel based on the position coordinates and the color value by invoking the depth prediction model to obtain predicted depth information of the second associated pixel; and
assigning a value to a corresponding second pixel in the second sub-depth image based on predicted depth information of each second associated pixel; and
determining the second sub-depth image with values assigned as the third sub-depth image.

18. The electronic device according to claim 17, wherein the instructions, when executed by the one or more processors, cause the electronic device to facilitate:
standardizing the position coordinates to obtain standard position coordinates;
standardizing the color value to obtain a standard color value; and
predicting the depth information of the second associated pixel based on the standard position coordinates and the standard color value by invoking the depth prediction model to obtain initial depth information of the second associated pixel; and
destandardizing the initial depth information to obtain the predicted depth information of the second associated pixel.

19. The electronic device according to claim 18, wherein the instructions, when executed by the one or more processors, cause the electronic device to facilitate:
acquiring a first pixel quantity in a horizontal axis direction and a second pixel quantity in a vertical axis direction of the color image;
subtracting 1 from the first pixel quantity to obtain a first reference quantity, and subtracting 1 from the second pixel quantity to obtain a second reference quantity;
determining a ratio of the horizontal coordinate to the first reference quantity as a standard horizontal coordinate; determining a ratio of the vertical coordinate to the second reference quantity as a standard vertical coordinate; and
combining the standard horizontal coordinate and the standard vertical coordinate into the standard position coordinates.

20. A non-transitory computer-readable storage medium, having computer-executable instructions stored thereon, the computer-executable instructions, when executed by one or more processors, cause an electronic device to facilitate:
acquiring a first sub-depth image that has depth information and a second sub-depth image that does not have depth information, wherein the first sub-depth image and the second sub-depth image are obtained by dividing a depth image corresponding to a color image, wherein the first sub-depth image corresponds to a first color area in the color image, and wherein the second sub-depth image corresponds to a second color area in the color image;
acquiring a depth prediction model, wherein the depth prediction model is obtained through training by taking pixels in the first color area in the color image as samples and taking corresponding depth information in the first sub-depth image as a label;
predicting depth information of each pixel in the second color area in the color image through the depth prediction model to obtain a third sub-depth image corresponding to the second color area; and
fusing the first sub-depth image and the third sub-depth image to obtain a complete depth image corresponding to the color image.
